(19) United States
(12) Patent Application Publication
(10) Pub. No.: US 2020/0223352 A1
(43) Pub. Date: Jul. 16, 2020

(54) SYSTEM AND METHOD FOR PROVIDING AUTOMATED DIGITAL ASSISTANT IN SELF-DRIVING VEHICLES

(71) Applicant: SAMSUNG ELETRÔNICA DA AMAZÔNIA LTDA., Campinas (BR)

(72) Inventors: Andre Toshio Kimura, Campinas (BR); Sang Hyuk Lee, Campinas (BR); Otavio Augusto Bizetto Penatti, Campinas (BR); Brunno Frigo Da Purificacao, Campinas (BR); Salatiel Quesler Ribeiro Batista, Campinas (BR)

(73) Assignee: SAMSUNG ELETRÔNICA DA AMAZÔNIA LTDA., Campinas (BR)

(21) Appl. No.: 16/379,860

(22) Filed: Apr. 10, 2019

(30) Foreign Application Priority Data
Jan. 14, 2019 (BR) 10 2019 000743.5

(51) Int. Cl. B60Q 1/50; G06N 20/00; G05D 1/00; G05D 1/02

(52) U.S. Cl. CPC B60Q 1/50; G06N 20/00; B60Q 9/00; G05D 1/0231; G05D 2201/0213; G05D 1/0088

(57) ABSTRACT

Method and system for displaying a digital human-like avatar in self-driving vehicles (SDV) including detecting a set of environmental data/characteristics in the vehicle surrounding area by sensors/cameras generating signals to be input for traditional machine learning classifiers on a computer vision module (CVM); receiving control system inputs from the sensors and processing actions to be performed; after receiving outputs from the control system, executing autonomous driving actions by an actuator system; and based on inputs from the CVM and a personalization module, combined with actions and car status information from the control system, generating a digital avatar performing human-like reactions/expressions/gestures to properly communicate/indicate the current and future actions of the SDV for external people on a SDV display device.

### TECHNICAL FIELD

The present invention provides an automated digital assistant capable of visually communicating via human body gestures with pedestrians or other drivers and that could incrementally be more polite, gentle and human during urban traffic interactions. The proposed digital assistant is also able to recognize body gestures from pedestrians and reply accordingly or even better than a real human predominantly during stressful situations or traffic dilemmas, that commonly lead to discussions and fights. The proposed method provides a new functionality (enhancement) for self-driving/autonomous/driverless vehicles, the ability to successfully interact with its surroundings.

### BACKGROUND

In traffic, reliance/trust is commonly made through intentional signaling between humans (driver to other driver, driver to pedestrian, etc.) indicating next intent actions. It is a common behavior of pedestrians to glance at the driver of the approaching vehicle before stepping into the road. One of the problems that arise when self-driving cars take to the road is the fact that the tacit communication (hand waves, head nods and other gestures or non-verbal communication) between drivers and pedestrians will no longer exist. It is not trivial (nor natural yet) to humans how these self-driving cars will “communicate” their intentions in an easy way to understand.

To solve this, some automobile manufacturers developed light systems and signs in the windscreen of the self-driving car. These light systems may signal/indicate to the pedestrians the actions of the self-driving car. For example, when the self-driving car brakes, the brake lights work for those who are watching from behind, but pedestrians waiting to cross ahead will have no signal/indication that the self-driving car will stop or will slow down.

In this sense, the said light system in the windscreen (or any other visible part in front of the self-driving car) is helpful and necessary to make the pedestrian aware of the car's next actions/moves. By taking into consideration the same example above, the front light system can blink slowly in red color to show the car is braking (slowing down). Analogously, the light system can show fast flashes in green color to indicate the car is accelerating, or a solid/steady light (for example, in yellow color) to indicate constant speed.

These existing light systems in the front of self-driving cars are certainly an evolution in the “car-to-pedestrian communication”, but there are some drawbacks, especially if we consider the “user friendliness” (the pedestrian experience). Since we have not (yet) a standard (universal protocol) to this “car-to-pedestrian communication”, different automobile manufacturers may implement different light colors or signs. Additionally, even considering that a communication protocol will be standardized and universally used (as stoplights and traffic signs), the learning curve of the pedestrian will not be immediate, and the communication will not be so humanized.

In fact, according to a survey made on 2016 to analyze people's attitudes toward self-driving cars available at https://www.popsci.com/people-want-to-interact-even-with-an-autonomous-car, 80% of all respondents said that, as pedestrians, they seek eye contact with the driver of a car at an intersection before they cross. This will be no longer possible when self-driving cars become commonplace. Self-driving cars do not have eyes to contact or a nod of recognition to give. Additionally, in a recent survey (2018), the American Automobile Association (AAA) found that 73% of Americans do not trust autonomous vehicles available at https://www.technologyreview.com/the-download/611190/americans-really-dont-trust-self-driving-cars/.

As observed, pedestrians generally wait for a “human gesture” (eye contact, head nods, hand gestures) to be sure that the driver (or, in this case, the self-driving car) had perceived/recognized them. Even when technologies and algorithms are autonomously driving the cars, people still need to find a way to recreate the subtle interactions that keep them safe on the streets. Therefore, it would be desirable a solution for self-driving cars based on these human behavior, i.e., a vehicle which is able to signal intentions to the environment around the vehicle (including pedestrians, bicycles, and other vehicles) and allows interactions with (more) humanized gestures.

There is a growing trend to propose solutions about how self-driving (autonomous) vehicles will communicate with the surrounding, especially nearby humans (pedestrians, cyclists, drivers of non-autonomous vehicles).

Patents documents US 20180072218 A1 titled “Light output system for self-driving vehicle”, and U.S. Pat. No. 9,902,311 B2 titled “Lighting device for a vehicle”, both by Uber Technologies Inc, describe a self-driving vehicle (SDV) comprising:
a sensor system comprising one or more sensors generating sensor data corresponding to a surrounding area of the SDV;
acceleration, steering, and braking systems;
a light output system viewable from the surrounding area of the SDV;
a control system comprising one or more processors executing an instruction set that causes the control system to:
   dynamically determine a set of autonomous driving actions to be performed by the SDV;
   generate a set of intention outputs using the light output system based on the set of autonomous driving actions, the set of intention outputs indicating the set of autonomous driving actions prior to the SDV executing the set of autonomous driving actions;
   execute the set of autonomous driving actions using the acceleration, braking, and steering systems; and
   while executing the set of autonomous driving actions, generate a corresponding set of reactive outputs using the light output system to indicate the set of autonomous driving actions being executed, the corresponding set of reactive outputs replacing the set of intention outputs.

In these patent documents, Uber Technologies Inc proposes a self-driving car comprising flashing signs (visual outputs, projector, audio output, etc.) to effectively communicate messages (about what the car is doing and what it plans to do) to pedestrians and others around it.

Patent document US20150336502A1 titled “Communication between autonomous vehicle and external observers”, by Applied Invention LLC, discloses a method for an autonomous vehicle to communicate with external observers, comprising:
receiving a task at the autonomous vehicle;
collecting data that characterizes a surrounding environment of the autonomous vehicle from a sensor coupled to the autonomous vehicle;
determining an intended course of action for the autonomous vehicle to undertake based on the task and the collected data;
projecting a human understandable output, via a projector that manipulates or produces light, to a ground surface in proximity to the autonomous vehicle; and
wherein the human understandable output indicates the intended course of action of the autonomous vehicle to an external observer.

Patent document U.S. Pat. No. 8,954,252B1 titled “Pedestrian notifications”, by Waymo LLC (former: Google LLC), relates to means to notify a pedestrian of the intent of a self-driving vehicle (i.e., what vehicle is going to do or is currently doing). More specifically, this patent document proposes a method comprising:
maneuvering, by one or more processors, a vehicle along a route including a roadway in an autonomous driving mode without continuous input from a driver;
receiving, by the one or more processors, sensor data about an external environment of the vehicle collected by sensors associated with the vehicle;
identifying, by the one or more processors, an object in the external environment of the vehicle from the sensor data;
determining, by one or more processors, that the object is likely to cross the roadway based on a current heading and speed of the object as determined from the sensor data; and
based on the determination, selecting, by the one or more processors, a plan of action for responding to the object including yielding to the object; and
providing, by the one or more processor, without specific initiating input from the driver, a notification to the object indicating that the vehicle will yield to the object and allow the object to cross the roadway.

Patent document U.S. Pat. No. 10,118,548 B1 titled “Autonomous vehicle signaling of third-party detection”, by State Farm Mutual Automobile Insurance Company, describes means to signal/notify a third-party who is external to the vehicle (e.g. pedestrian, cyclist, etc) that the vehicle has detected the third-party presence. More specifically, this patent document proposes a method comprising: monitoring vehicle environment via sensors; detecting, using sensor data, the presence of a third-party in vehicle environment; generating third-party detection notification; and transmitting signals that include indication of third-party detection notification. In some situations, a two-way dialog may be established, receiving signal from third-party in response.

All these aforementioned patent documents disclose means to communication between autonomous vehicle and external people (pedestrian, cyclists and drivers of other cars). This communication is generally established through light signs, visual outputs, projectors, audio output, etc. Differently from the present proposal, none of these patent documents claim a digital assistant/avatar (face and human gestures) as a virtual representation of a human being (driver, passenger, etc.) that would be capable of visually and dynamically communicate with pedestrians or other drivers and that could incrementally be more polite, gentle and human during urban traffic interactions.

In addition to the existing patents, there are also some solutions (mainly prototypes or concepts developed by automobile manufacturers) related to autonomous vehicles that provide means to communicate with external people.

Ford proposed a lighting system (flashing lights) above the windscreen to communicate with pedestrians/cyclists (available at http://www.ibtimes.co.uk/watch-this-ford-employee-dress-van-seat-understand-driverless-car-reactions-1639388). For example, the light system blinks slowly to show the car in coming to a stop—brake lights work for those behind, but pedestrians waiting to cross ahead need to know that the car plans to stop for them. Fast flashes indicate the car is accelerating, while solid lights are shown when the vehicle is travelling at a steady speed.

Semcon, a Swedish company for product development based on human behavior, developed a prototype of autonomous car (Smiling Car) that displays a big smile (using a set of LEDs in the front part of the car) to show that it has detected the pedestrian and it will stop (available at https://semcon.com/smilingcar/). The Smiling Car concept is part of a long-term project to help create a global standard for how self-driving cars communicate on the road.

In 2016, automobile manufacturer Bentley presented a concept supercar EXP10 Speed 6 that could provide a VR/holographic assistant (available at https://www.mirror.co.uk/lifestyle/motoring/look-inside-futuristic-bentley-reveals-7700675). But this personal assistant supports the passengers (people inside the vehicle), and there is no sufficient technical description to infer/suppose that it could be used to provide notifications/messages/outputs for pedestrians, cyclists or drivers from other cars (people outside the vehicle). Purposes and motivation of this Bentley solution are completely different from the method and system of the present invention.

Recently (2018), Jaguar Land Rover is experimenting with visual aids that help pedestrians/cyclists understand AV behavior (available at https://www.fastcompany.com/90231563/people-dont-trust-autonomous-vehicles-so-jaguar-is-adding-googly-eyes). More specifically, the engineering team at Jaguar recently partnered with cognitive scientists to propose a solution with huge googly eyes on the front of its prototype vehicle. Jaguar Land Rover's Future Mobility division designed a set of digital eyes that act like driver's eyes, following the objects they “see” (using cameras and LiDAR sensors, a technology similar to radar which uses laser to sense/scan objects). The pedestrians then have the sensation/confirmation that the vehicle is aware of their presence, and they feel safer.

The proposed invention is contextualized in the driverless/autonomous/self-driving vehicle scenario. In the next few years, driverless cars will be part of our lives, commonly present in the roads and streets. By driverless cars (or self-driving cars, or complete autonomous cars) may be defined as cars that can drive themselves without any human interaction (SAE International Level 4 or 5), other than entering/saying a final destination. Many automobile manufacturers and technology companies are currently researching and developing the main technologies that will enable this concept in near future.

The proposed invention relies on (and take advantages of) all technologies that enable driverless/autonomous/self-driving vehicles: systems comprising a plurality of sensors to sense/detect/recognize a set of environmental data/characteristics in the surrounding area of the vehicle; systems comprising a plurality of actuators to execute a set of autonomous driving actions (acceleration, braking, steering, lights, etc.); control system comprising processors to receive inputs from sensor systems and provide outputs to actuator systems; navigation/geolocation systems; etc.

Technologies and solutions related to computer vision in general, and more specifically pattern recognition and object/person recognition are important to correctly detect, recognize and/or identify many kinds of objects during vehicle navigation, especially considering those who represent pedestrians/humans and other cars.

Gesture Recognition and Affective Computing concepts and solutions can be used to capture and understand/interpret human gestures and body expressions, in order to establish a more humanized interaction between the self-driving car's avatar and human external observers (e.g. other drivers or pedestrians).

Considering that the main purpose of the present invention is to provide a human-like virtual avatar (preferably through the windshield of the self-driving car but can be any other available external display) to interact with the human pedestrians/drivers, it also relies on Computer Graphics, Augmented Reality (AR), Virtual Reality (VR), and Mixed Reality (MR).

Finally, considering the windshield (general display), technologies like transparent, curved displays are also relevant.

### SUMMARY OF THE INVENTION

Considering the current drawbacks, gaps and opportunities for the “car-to-pedestrian communication”, the present invention proposes a solution for self-driving cars based on humanized gesture interactions.

The proposed invention relies on technologies such Augmented Reality (AR), Virtual Reality (VR), Mixed Reality (MR), Affective Computing, Gesture Recognition, Object/Person Recognition and Artificial Intelligence in general, to provide a human-like digital avatar, preferably through the windshield of the self-driving car (or any other display available), that could interact with the pedestrian or other human drivers.

This digital avatar can be a virtual image of the car owner, or the virtual image of one of the passengers, or yet any virtual image of a human-like face. A good example of avatars that can be used are the well-known “AR Emojis”. However, the invention is not limited to them, and more realistic images/avatars of human faces can be used as well.

The present invention provides a new functionality or enhancement for upcoming self-driving cars, which is the ability to start and maintain a humanized interaction with pedestrians or other cars' drivers. Usage/Application scope is large, since it is possible to apply the proposed solution on multiple models of self-driving cars.

### BRIEF DESCRIPTION OF THE DRAWINGS

The objectives and advantages of the current invention will become clearer through the following detailed description of the example and non-limitative pictures presented at the end of this document.

FIG. 1A discloses an example of a preferred embodiment of the invention, displaying the avatar and additional information in the self-driving car windshield or another front display.

FIG. 1B discloses another example of a preferred embodiment of the invention, displaying the avatar and additional information in the rear window or another rear display of the self-driving car.

FIG. 2 discloses that proposed avatar relies on existing modules of self-driving car (Sensor Systems and Control System) to determine a proper human-like reaction/gesture and present additional information to external people, based on a set of actions (established by Control System to Actuator Systems).

FIG. 3 discloses the proposed avatar comprising Computer vision module, Personalization module and Avatar generator module.

FIG. 4A disclose an example when the self-driving car detects a pedestrian, the proposed avatar starts to communicate with him/her, in order to inform the next planned actions. In this example, the avatar informs that the self-driving car is aware of the pedestrian presence and the next action will be slow down the speed.

FIG. 4B discloses that the avatar may also be displayed on rear window and communicate to the driver at the car behind, warning about the next planned actions. In this example, the avatar informs that a pedestrian is crossing ahead, and the self-driving car is slowing down.

FIG. 4C discloses that the avatar keeps providing/updating status/feedbacks to make the pedestrian feel comfortable and safer.

FIG. 4D discloses that the avatar may also be displayed on rear window, providing/updating status/feedbacks to the driver at the car behind.

FIG. 4E discloses an example in which as the self-driving car stops before the pedestrian, the avatar changes its expression/gestures, updates the info/status and recommends the pedestrian to cross.

FIG. 4F discloses that the avatar may also be displayed on rear window, informing to the driver at the car behind that pedestrian will cross the street, and the self-driving car stopped (0 mph).

FIG. 4G discloses an example in which while the pedestrian is crossing the street, the avatar changes the expression to indicate that the self-driving car is waiting.

FIG. 4H discloses that the avatar may also be displayed on rear window, and communicating to the driver at the car behind that the pedestrian is still crossing, and the self-driving car stopped (0 mph).

FIG. 4I discloses an example in which after the pedestrian crosses the street, the gesture/expression of avatar may be changed again (e.g.: a standard expression), acknowledges the conclusion of pedestrian action, inform next actions and updates the info/status of self-driving car.

FIG. 4J discloses that the avatar may also be displayed on rear window, presenting a thankful message to the driver at the car behind, and informing that the self-driving car will continue to ride (3 mph).

FIG. 4L discloses the 5 situations/steps of the example (use case) for the avatar displayed in the windshield or another front display (communication to the pedestrian). The avatar gestures/expressions and the information change according to the situation/environment.

FIG. 4M discloses the 5 situations/steps of the example (use case) for the avatar displayed in the rear window or another rear display (communication to the car behind). The avatar gestures/expressions and the information change according to the situation/environment.

### DETAILED DESCRIPTION OF THE INVENTION

Considering the human behavior related to self-driving cars (i.e., people want to be somehow notified when they are seen by an automated vehicle), the present invention proposes a digital avatar to communicate the current actions and the future actions (intentions/plans) of the said self-driving car for external people.

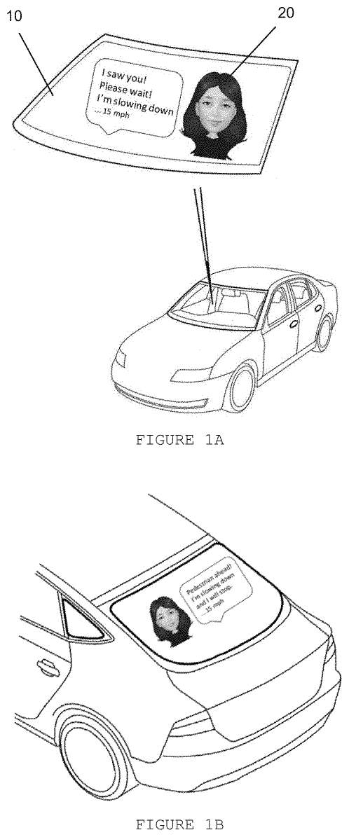

FIG. 1A discloses an exemplary embodiment of the proposed solution. A self-driving car comprises at least one external display 10, wherein the proposed avatar 20 is displayed. The avatar 20 is a digital assistant that virtually— and visually—represents a human being (for instance, a representation of the car owner, one of the passengers, etc.) or an animated character able to reproduce human form, expression and gestures.

In order to better signaling to the external people (pedestrians, cyclists, other drivers), the said avatar 20 may be displayed on the self-driving car windshield. Alternatively, or complementarily, the proposed avatar may also be displayed on the side and rear windows (FIG. 1B). It is necessary to equip the self-driving car with external displays, for instance substituting the window's glass, in order to present the proposed avatar to the external people. One possibility, among others, could be installing curved/convex/semispheric display on the top of the car roof, what could provide 360 degrees avatar visibility.

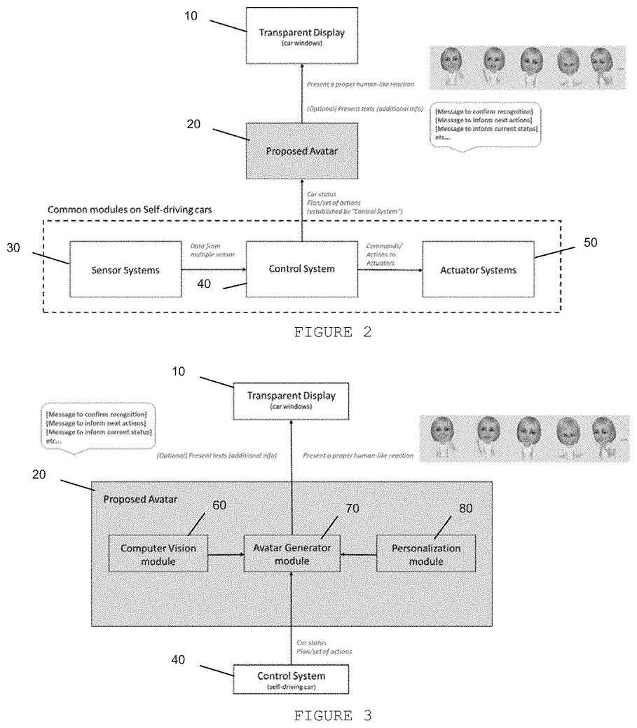

According to FIG. 2, the proposed avatar 20 relies on all other existing technologies and modules/systems that enable driverless/autonomous/self-driving vehicles: sensor systems 30 to sense/detect/recognize a set of environmental data/characteristics in the surrounding area of the vehicle (e.g.: temperature, lane marks, other vehicles, pedestrians, etc.); control system 40 comprising processors to receive inputs from sensors, prepare/establish a plan/set of actions and provide outputs to actuators; actuator systems 50 to execute a set of autonomous driving actions (e.g.: acceleration, braking, steering/swerve, lights, honk, etc.); navigation systems to establish geolocation; etc.

Based on the plan/set of actions (established by the control system to control/command actuator systems), the avatar 20 may determine a plurality of human-like reactions/expressions/gestures (e.g.: hand waves, head nods, many other gestures that indicate intentions) to properly communicate/indicate the current actions and the future actions (intentions/plans) of the said self-driving car for external people.

Besides displaying the avatar 20 gestures, it can also communicate via text and/or images to present additional information and, if necessary/allowed, some self-driving car status (e.g.: accelerating, breaking, stop, current speed, etc.).

FIG. 3 discloses a more detailed view about the proposed avatar 20, comprising: computer vision module 60, personalization module 80 and avatar generator module 70.

Computer vision module 60: For understanding the environment around the vehicle many existing approaches for autonomous vehicles rely on Artificial Intelligence and machine learning techniques, some of them including analysis of images/videos obtained by cameras available in the vehicle. According to the present invention, in order to provide more humanized communications with external people, computer vision techniques using information obtained from cameras installed in the vehicle are employed.

The proposed computer vision module 60 is able to identify/detect:
a plurality of pedestrian poses (e.g., standing up, arms up, pointing to the car, etc.);
a plurality of human actions (e.g., walking, standing up, running, biking, using phone, etc.);
a plurality of gestures (e.g., hand waving, head nod, thumbs up, “okay” gesture, left/right turn signal with arms, stop gesture with hand, etc.);
gaze (e.g., looking to the car, looking to smartphone, distracted or looking to somewhere else);
face expressions (e.g., happy, worried, sad, neutral, etc.);
gender recognition (male, woman);
age estimation (e.g.: kid, elder, etc.); and
fashion/clothes recognition.

All these elements may contribute to increase the quality of human-like interactions of the self-driving car (i.e., the avatar) with the pedestrian/cyclist/driver, in different traffic situations and conditions.

For the pedestrian/cyclist detection algorithm, the proposed computer vision module 60 can be implemented using different approaches:
One approach is to extract features from images/videos and use these features (hand-crafted descriptors) as input for traditional machine learning classifiers, including, but not limited to, support vector machines (SVM), random forest, neural networks, nearest neighbors, etc. The features can be based on histograms of oriented gradients (HOG), local binary patterns (LBP), color histograms, bags of visual words, etc.
A second approach is implemented by part-based methods, including Deformable Part Models (DPM) (reference is made to Felzenszwalb, P. F., Girshick, R. B., McAllester, D., & Ramanan, D. (2010). “Object detection with discriminatively trained part-based models” on IEEE transactions on pattern analysis and machine intelligence, 32(9), 1627-1645).
Another approach refers to integrate feature extraction/learning with object detectors (classifiers) trained for pedestrian/cyclist detection, including, but not limited to, known techniques such as Fast R-CNN, Faster R-CNN, YOLO (You Only Look Once), SSD (Single Shot Multibox Detector) and other deep learning techniques for real-time object detection.

In all these approaches, the computer vision module 60 needs to be trained with the desired functionality. For instance, if the car should recognize human actions, a classifier for action recognition should be trained in order to deploy it to the vehicle afterwards. The same applies for gaze estimation, pose estimation, gesture recognition, face expression recognition, gender recognition, age estimation, etc.

Personalization module 80: Car owners or passengers/riders can personalize the avatar 20 according to their preferences, like choosing male or female character, hair style, skin color, accessories, etc. Alternatively, the avatar 20 could also be an animated character of user preference (e.g.: a famous cartoon character, etc.).

The avatar 20 is also personalized depending on external conditions, including, for instance, weather, traffic, time of the day, etc. In cold weather, for instance, the avatar 20 could use cap and gloves; in sunny days, the avatar could use sunglasses. Also depending on external conditions, the messages could be changed/personalized (“Good morning!”, “Have a great evening”, “Stay tuned, traffic is heavy”, etc.).

For example, since the Computer Vision module 60 is able to detect an elderly pedestrian, the avatar 20 may present more formal/respectful messages. In case of recognizing a kid, the avatar 20 could change appearance to a cartoon character and present more informal/relaxed messages. The same personalization could be done regarding the pedestrian gender (e.g.: “Dear lady, please cross”, “Hello, sir. I saw you!”, etc.). Considering the Computer Vision module 60 has means for fashion/clothes recognition, this could improve the Advertisement/Service feature, suggesting shopping options based on the pedestrian clothes and accessories.

Avatar generator module 70: Based on the inputs from Computer vision module 60 and Personalization module 80, combined with the plan/set of actions and car status information from the Control System, this avatar generator module 70 generates (or updates) a digital avatar 10 to display. This avatar generation can be implemented using computer graphics, facial mapping/scanning/rendering, machine learning, etc. In fact, it can operate in a similar manner to the current “AR Emoji” creation procedure of Samsung®. A library containing pre-set expressions/gestures gives a good flexibility in the characterization of several situations using the avatar 20.

Also based on inputs from Computer vision module 60 and Personalization module 80, combined with the plan/set of actions and car status info from the Control System, the Avatar generator module 70 may (optionally) prepare text messages to reinforce communication with external people, for instance, a message to confirm presence detection, present the car status (e.g.: accelerating, breaking, stop, current speed, etc.), current actions and the future actions (intentions/plans, e.g.: “I will stop”), etc.

There are some possibilities regarding the visibility/presence of the avatar 20. According to a preferred embodiment of the invention, the digital avatar 20 is permanently presented on display 10 during the vehicle trip/ride. During the car movement/trip, the “always on display” digital avatar 20 can be just modified/customized based on one or more (combined) external conditions.

Alternatively, another possibility is to keep the avatar 20 disabled (not visible) when no action/communication is necessary to be displayed. According to one or more (combined) external conditions, whenever the avatar needs to communicate any information/intention/action of the self-driving car, then the avatar appears in the windshield or any external display 10 available.

Some of the main external conditions that changes the avatar status (i.e., when the avatar detects/identifies one or more of these conditions, the avatar becomes enabled/visible—if it was previously disabled/invisible—or change appearance to simulate a reaction of acknowledgement—if it was already enabled/visible) are listed below:
Pedestrian/cyclist/car/object detection (e.g.: person, car, animal, etc.);
Presence of a traffic authority, emergency/rescue or police car;
Surrounding environment (e.g. rainy, sunny, snow, day, night, etc.);
Geolocation (e.g.: crowd street, village road, highway, off road, etc.);
Self-driving car condition/status (e.g.: current speed, number of passengers, previous history, etc.);
Some specific self-driving car movements (e.g.: parking, starting/moving after a stop position, change road lane, braking, significant change of speed, turning right/left, reverse gear, etc.).

### Detailed Example of Practical Usage

Suppose a pedestrian suddenly appears in the corner of the street. Using its multiple sensors (e.g.: LiDAR, 3D camera, ultrasonic and/or infrared detectors, etc.), the self-driving car (via “Sensor System”) detects the pedestrian. In parallel, and according to its multiple sensors, the self-driving car (“Control System”) also realizes that it is safe to slow down the speed and stop before the cross (for example, the car behind is at a long, safer distance), so that the pedestrian can safely cross the street. Therefore, the self-driving car (“Control System”) establishes a plan/set of actions to command the actuators (in this case, braking the car until it stops before a distance range).

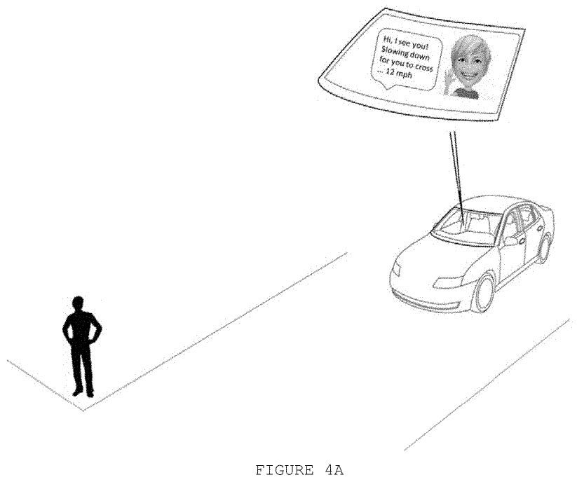

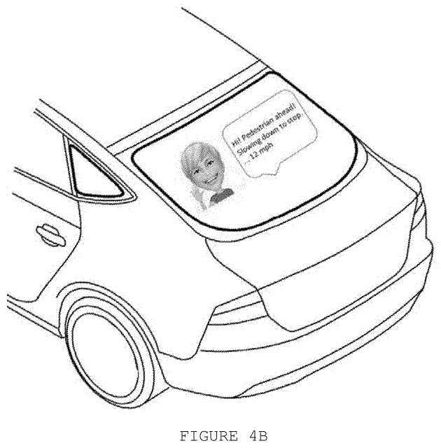

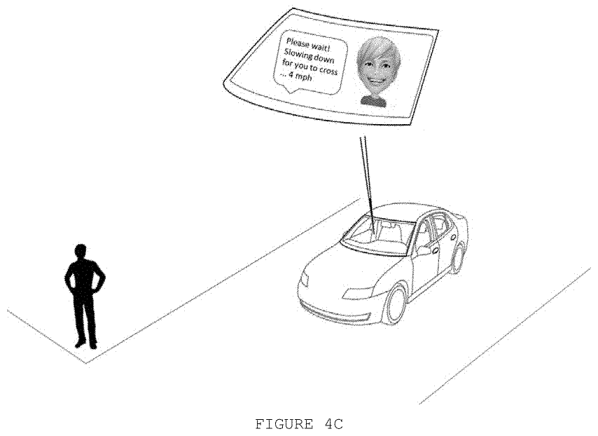

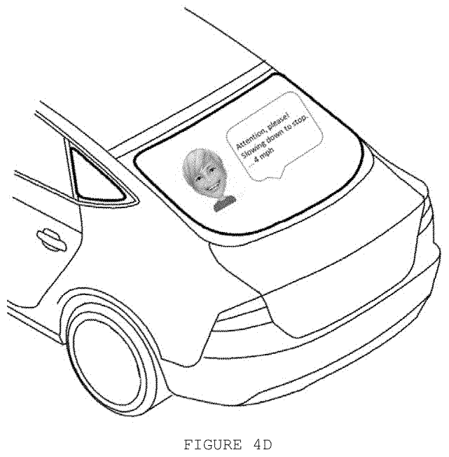

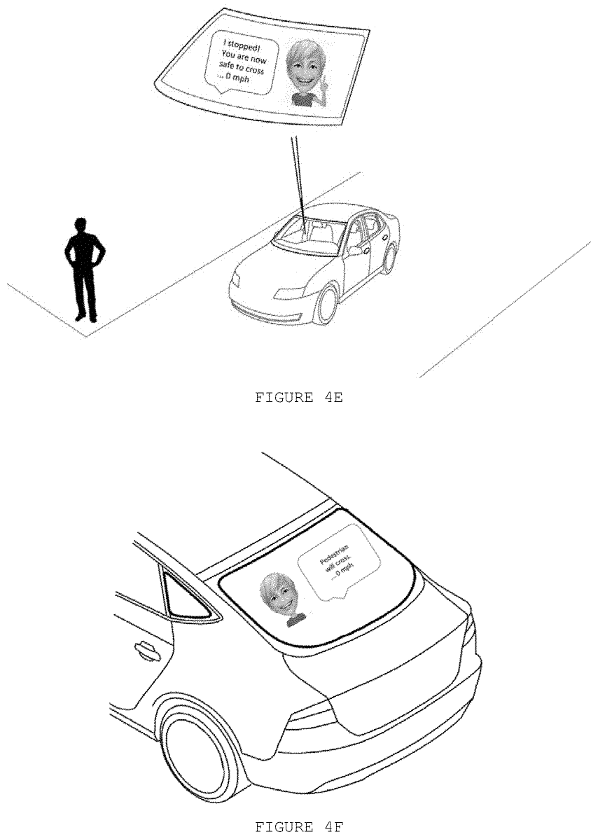

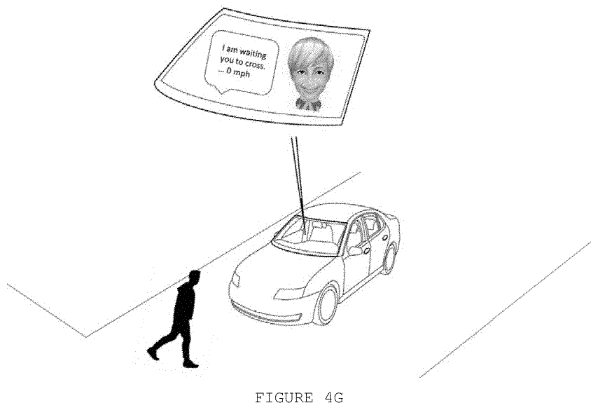

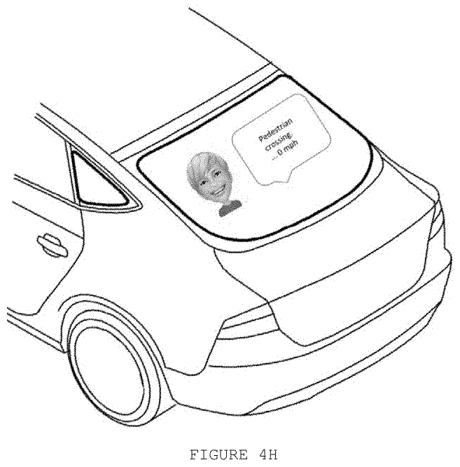

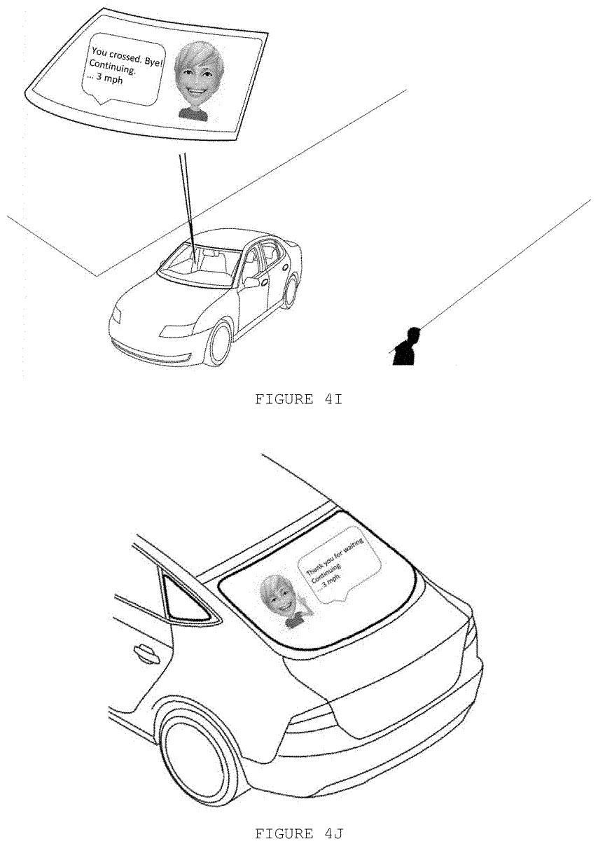

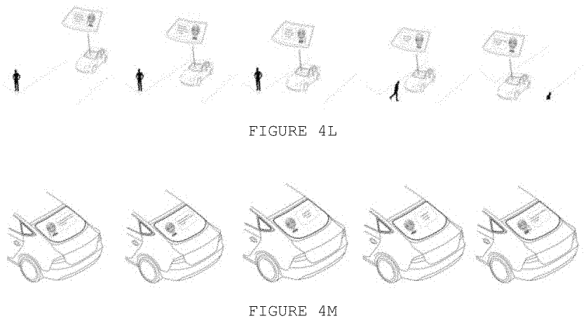

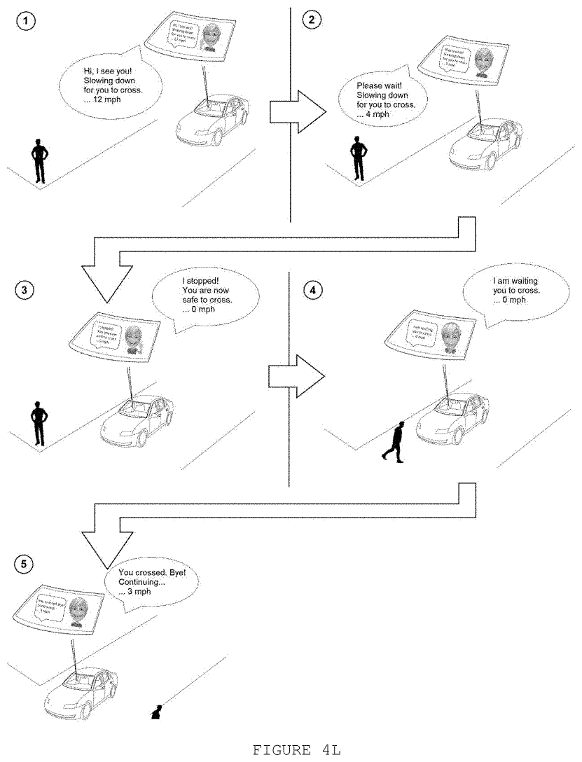

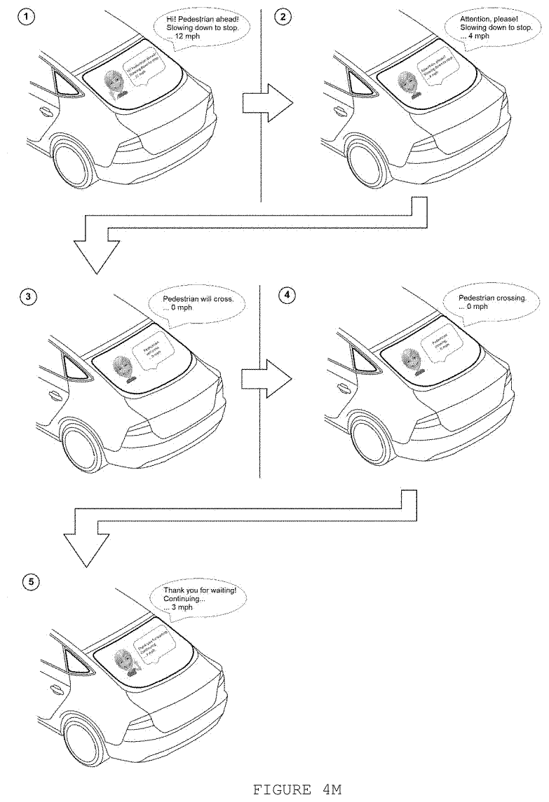

Based on this plan/set of actions, the proposed invention determines expressions and reactions of the human-like avatar, and some additional info to clearly communicate the self-driving car intentions (current and next actions). According to FIG. 4A, in a first moment, it is displayed a greeting avatar, which communicates to the pedestrian:
that self-driving car is aware of his/her presence (e.g.: “Hi! I see you!”);
the next planned actions (e.g.: “Slowing down for you to cross”);
the self-driving car status (e.g.: current speed, “12 mph”).

Complementarily, as shown in FIG. 4B, the avatar may be displayed on rear window and communicate to the driver at the car behind:
detection of a new fact that will demand further actions (e.g.: “Hi! Pedestrian ahead!”);
the next planned actions (e.g.: “Slowing down to stop”);
the self-driving car status (e.g.: current speed, “12 mph”).

In the following moments, shown in FIG. 4C, as the self-driving car approaches the cross, the avatar keeps providing status/feedbacks to make the pedestrian feel comfortable and safer. In this example, it can change the gesture/expression of the avatar (not greeting anymore) and communicates to the pedestrian:
a recommendation (e.g.: “Please wait!”);
reinforce next planned actions (e.g.: “Slowing down for you to cross”);
update the self-driving car status (e.g.: current speed, “4 mph”).

Complementarily, in FIG. 4D, the avatar is displayed on rear window and communicates to the driver at the car behind:
a recommendation (e.g.: “Attention, please!”);
reinforce next planned actions (e.g.: “Slowing down to stop”);
update the self-driving car status (e.g.: current speed, “4 mph”).

After a few moments, in FIG. 4E, the self-driving car stops before the pedestrian. The gesture/expression of avatar may be changed again (e.g.: a positive sign/gesture to indicate completion of action), and communicates to the pedestrian:
the completion of the action (e.g.: “I stopped!”);
a recommendation (e.g.: “You are now safe to cross.”);
update the self-driving car status (e.g.: current speed, “0 mph”).

Complementarily, in FIG. 4F the avatar may be displayed on rear window and communicates to the driver at the car behind:
next actions (e.g.: “Pedestrian will cross.”);
update the self-driving car status (e.g.: current speed, “0 mph”).

While the pedestrian is crossing the street in FIG. 4G, the gesture/expression of avatar may be changed again (e.g.: a sign/gesture to indicate the self-driving car is waiting), and communicates to the pedestrian:
the current action (e.g.: “I am waiting you to cross.”);
the self-driving car status (e.g.: current speed, “0 mph”).

Complementarily, in FIG. 4H the avatar may be displayed on rear window and communicates to the driver at the car behind:
the current action (e.g.: “Pedestrian crossing.”); the self-driving car status (e.g.: current speed, “0 mph”).

After the pedestrian crosses the street in FIG. 41, the gesture/expression of avatar may be changed again (e.g.: a standard expression), and communicates to the pedestrian:
the recognition that the pedestrian has concluded his/her action (e.g.: “You crossed. Bye!”);
the next action (e.g.: “Continuing”); update the self-driving car status (e.g.: current speed, “3 mph”).

Complementarily in FIG. 4J, the avatar may be displayed on rear window and communicates to the driver at the car behind:
a message to inform that the pedestrian has concluded his/her action (e.g.: “Thank you for waiting.”);
the next action (e.g.: “Continuing”);
update the self-driving car status (e.g.: current speed, “3 mph”).

The FIG. 4L shows a synthesis to facilitate the understanding of the above example, in the case of the avatar displayed on the windshield (front view—communication to pedestrian).

The FIG. 4M shows a synthesis to facilitate the understanding of the above example, in the case of the avatar displayed on the rear window (back view—communication to driver in the car behind).

The exemplary situation detailed above is also valid when the self-driving car detects an unexpected people crossing the street (e.g. a drunken person, a person who tries to cross the street using a smartphone, or any other situation when a person tries to cross without proper attention). As explained above, the usual/traditional or existing sensing systems of self-driven vehicles already consider this kind of unexpected situation, so the proposed avatar receives the information from car sensor systems and control systems to provide the adequate response/reaction for this situation (e.g. present a warning message to the pedestrian and to surrounding cars, while slow down/ stop the car).

### Complementary Outputs:

Besides the avatar itself (which may be displayed/presented in the windshield, rear window and other possible external displays of the car), other existing car elements/actuators can be used in combination with the avatar (e.g. headlight, lantern, turn signal light, tail-lamp, horn/horn). It could also be considered the usage of speakers to audibly interact with the pedestrians: that could be useful for an emergency scenario or even to communicate with visually impaired people.

As currently there is no standardization for autonomous vehicles signaling, the present invention proposes mapping some car elements/actuators with the criticality level of the avatar communications. For instance, when the car stops for pedestrians to cross the street, besides showing the avatar for this condition, the car can blink the front headlight.

When the car faces an urgent/critical situation, for instance, a hard brake to avoid running over a pedestrian, the car can also use the horn in combination with the avatar. When no critical situation is detected, no car element is necessary to be used (the avatar can be still displayed, or also become invisible).

### Other Use Cases/Examples/Scenarios:

Self-driving car stops, but the pedestrian is still waiting to cross:

If, for example, the car already indicated that it will stop or the car has already stopped but the pedestrian is still waiting to cross (i.e., the computer vision module did not recognize the action of walking or running by the pedestrian), the avatar may change the message or even provide other type of alert (e.g., sound, flash light) highlighting that the pedestrian can cross the street. In addition, if the car recognizes that the pedestrian will not cross the street, the avatar can indicate that the car will accelerate again, and the pedestrian should then wait to cross.

### Multiple Pedestrians:

In the case of multiple pedestrians, the computer vision module can identify groups of pedestrians walking (i.e., action recognition), pedestrians distracted (e.g., talking to each other, using phone) and personalize the message in such cases. In the case of multiple pedestrians crossing the street, the car can determine that it will wait some more people to cross (i.e., this requires the computer vision module to count the number of people crossing), present a message indicating that it will accelerate again in some seconds and then accelerate, for instance. The avatar could also alert the pedestrians that it will wait only more X seconds or Y pedestrians before accelerating again.

In such case of multiple pedestrians, in a preferred embodiment of the present invention, the proposed avatar sends a unique, similar message to all group of pedestrians (and not a specific message to every single pedestrian). Sending differentiated messages to each specific pedestrian can be too complex (manage each group, select specific messages, etc.) in a very short time/period of response (e.g. fraction of seconds). Also, present multiple messages on the display could be confusing for the pedestrians. However, if it happens that, for instance, the group of people finishes crossing the street, but an elderly pedestrian is still crossing, the avatar could personalize the message to that specific person (e.g. “I see you are still crossing. Take your time, I will wait”).

### Direct Vehicle-To-Vehicle Communication:

Initially, it is considered that the solution (avatar) runs locally in the car, making decisions according to the environment detected by the sensors of the car itself. The avatar and the messages are then presented at one or more displays/windows of the self-driving car, so that people (pedestrians, cyclist, human drivers, etc.) can see it from outside.

The vehicle-to-vehicle (V2V) communication is the communication standard used in the method and system of the present invention, which is a wireless protocol similar to Wi-Fi (or cellular technologies, like LTE). In this scenario, vehicles are “dedicated short-range communications” (DSRC) devices, constituting the nodes of a “vehicular ad-hoc network” (VANET). V2V communication allows vehicles to broadcast and receive omni-directional messages (with a range of 300 meters), creating a 360-degree “awareness” of other vehicles in proximity (main exchanged information is: speed, location, and direction/heading). Vehicles equipped with this technology can use the messages from surrounding vehicles to determine potential crash threats as they develop. The technology can then employ visual, tactile, and audible alerts—or, a combination of these alerts—to warn drivers. These alerts allow drivers the ability to act to avoid crashes.

Taking advantage of the V2V protocol, the present invention can communicate with other vehicles (autonomous or human-driving cars), sending messages with necessary information. In this case, the proposed invention uses the existing V2V protocol as a standard platform. It is not the scope of the invention to propose a novel V2V communication system.

Additionally, since the vehicle-to-vehicle communication is not the main purpose of this invention, an alternative solution would be implemented through a future server/cloud central system to exchange traffic information. This way, both self-driving and human-driving cars will be able to exchange messages.

Communication with the Driver at Another Car:

Human driver in the human driving car can see and notice the avatar in self-driving car, in the same way that a pedestrian can do (i.e. by viewing the avatar and the message in the self-driving car's display). In the case of the car communicating with another car that is conducted by a human (i.e., not a self-driving car), the avatar can provide personalized messages for some situations. For instance, if there is a sudden stop by a human-driven car and a self-driving car is coming behind, the avatar in the self-driving car indicates that it has already detected the sudden stop and that it is slowing down, avoiding the human driver to think that the car behind will not stop.

Additionally, based on V2V communication described above, the self-driving car (avatar) also transmits a message/info to be displayed on the entertainment system of the human-driving car.

### Advertisement/Service:

The avatar informs the car actions/status, like explained in the examples above, and include a personalized add for the pedestrian, for instance. Considering the Computer Vision module has means for fashion/clothes recognition, the avatar could suggest store options based on the pedestrian clothes and accessories.

For instance, if the computer vision module detects that there is a pedestrian using glasses, the avatar shows car status/actions and suggest shopping options related to new glasses. If it is raining and the computer vision module detects that some pedestrians do not have umbrellas, the avatar can show car status/actions and suggest nearby stores that sell umbrellas.

Advertisement can also be shown regardless the recognition of the pedestrians. For instance, if the car detects hot weather, the avatar can show, besides car status/actions, nearby ice cream stores or air-conditioning shopping options, etc.

In view of all that has been described in this document, the proposed method and system contribute to increasing the confidence and comfort of external people (pedestrians, cyclists, drivers in other cars) when interacting with a self-driving car.

Although the present disclosure has been described in connection with certain preferred embodiments, it should be understood that it is not intended to limit the disclosure to those particular embodiments. Rather, it is intended to cover all alternatives, modifications and equivalents possible within the spirit and scope of the disclosure as defined by the appended claims.

1. A system for providing automated digital assistant in a self-driving vehicle comprising:
a computer vision module employing computer vision techniques using information obtained from cameras/sensors installed in the vehicle for understanding the environment around the autonomous vehicle;
a personalization module for customizing the digital assistant/avatar according to the vehicle owner's preference and considering external conditions detected by sensors/cameras; and
a digital assistant/avatar generator module generating an avatar based on the inputs from the computer vision module and personalization module, combined with the plan/set of actions and vehicle status information from a control system of the vehicle.

2. The system, according to claim 1, wherein the digital assistant/avatar generator module is able to generate:
a digital assistant/avatar able to perform a plurality of human-like reactions, expressions, gestures and signs to properly communicate/indicate the current actions and the future actions of the self-driving vehicle for external people; and
a plurality of messages to provide additional information about actions and status of the self-driving car, and acknowledgement of pedestrian presence and actions.

3. A method for providing automated digital assistant in a self-driving vehicle comprising the steps of:
detecting a set of environmental data/characteristics in a surrounding area of the vehicle by a plurality of sensors/cameras generating signals to be input for traditional machine learning classifiers on a computer vision module;
receiving by of a control system the-inputs from the sensors and processing a set of actions to be performed;
after receiving outputs from the control system, executing a set of autonomous driving actions by actuator system;
based on inputs from the computer vision module and a personalization module, combined with the plan/set of actions and car status information from the control system, generating by an avatar generator module a digital avatar performing a plurality of human-like reactions/expressions/gestures to properly communicate/indicate the current actions and the future actions of the self-driving vehicle for external people on a transparent display device of the vehicle.

4. The method, according to claim 3, wherein the machine learning classifiers include support vector machines, random forest, neural networks and nearest neighbors.

5. The method according to claim 3, wherein the avatar communicates via text and/or images to present additional information and, if necessary/allowed, some self-driving vehicle status.

6. The method, according to claim 3, wherein avatar generation can be implemented using computer graphics, Augmented Reality (AR), Virtual Reality (VR), and Mixed Reality (MR) know-how, facial mapping/scanning/rendering and machine learning.

7. The method, according to claim 3, wherein avatar is displayed on a vehicle windshield, side window, rear window or any external display.

8. The method, according to claim 3, further comprising customization of the avatar by means of a personalization module according to the user preference.

9. The method, according to claim 3, wherein the digital avatar is permanently presented on the display during the vehicle trip/ride.

10. The method, according to claim 3, wherein the digital avatar alternatively disappears when no action/communication is necessary and reappears whenever the computer vision module detects the presence of an external person or object.
